(19) United States
(12) Patent Application Publication
(10) Pub. No.: US 2017/0043965 A1
(43) Pub. Date: Feb. 16, 2017

(54) SAMPLE COLLECTION

(71) Applicant: Reflex Technology International Pty Ltd, Balcatta (AU)

(72) Inventors: Fred Blaine, Dulwich (AU); James Barry Reilly, Bayswater (AU); Andrew Beach, Balcatta (AU)

(21) Appl. No.: 15/235,465

(22) Filed: Aug. 12, 2016

(30) Foreign Application Priority Data
Aug. 14, 2015 (AU) 2015903274

(51) Int. Cl. B65G 65/02; E21B 21/06; B65G 15/00

(52) U.S. Cl. CPC B65G 65/02; B65G 15/00; E21B 21/065; B65G 2814/0314

(57) ABSTRACT

The collection system (10) for collecting drilling cuttings removed from drilling fluid returns during borehole drilling for the purpose of sampling. The collection system (10) has a conveyor means (21), a transfer (23), and a loading means (25). The loading means (25) is provided for sequentially positioning a plurality of sample collection containers (27), such as sample collection bags, at a collection zone (24) to receive discrete quantities of the drilling cuttings via the transfer (23) The sample collection bags may be supported in holders (29). The discrete quantities of the drilling cuttings provide representative samples to be stored individually in the sample collection containers (27). The loading means 25 comprises a carousel (33) adapted to support the sample collection containers (27) and index them sequentially into position at the collection zone (24). Once a filled sample collection bag moves away from the collection zone (24) upon indexing of the carousel (33), the filled sample collection bag can be removed from its holder (29) and replaced with an empty bag in readiness to be filled when next at the collection zone (24).

### TECHNICAL FIELD

The present invention relates to collection of samples.

The invention has been devised particularly, although not necessarily solely, in relation to sample collection systems and methods for use in exploration drilling. In particular, the present invention is concerned with collection of drilling cuttings removed from drilling fluid returns during borehole drilling, for the purpose of using the collected cuttings for sampling.

### BACKGROUND ART

The following discussion of the background art is intended to facilitate an understanding of the present invention only. The discussion is not an acknowledgement or admission that any of the material referred to is or was part of the common general knowledge as at the priority date of the application.

In exploration drilling such as mineral exploration drilling, there is a need obtain representative samples for analysis to determine the geology of the earth formation being drilled.

The current practice when performing exploration drilling, such as for example mineral exploration drilling, is to send samples obtained during the course of drilling (e.g. core samples obtained from diamond drilling) to a laboratory (which is usually located remotely from the drilling site) for analysis. This usually results in a significant delay between the time that the samples are obtained and the time that the results of the analysis of the samples by the laboratory become available. The delay can be in the order of weeks or months. The delay in obtaining the analysis means that there is minimal, if any, feedback available for use in making decisions while drilling.

In an effort to reduce the aforementioned delay, there have been proposals to use drilling cuttings as a source of analysis to determine the geology of the earth formation that is being drilled. In this way, the drilling cuttings would constitute a continuous stream of sample material representative of the geological formation being drilled.

Typically in a drilling process, the drilling cuttings are conveyed to ground surface in a fluid, such as a drilling fluid (commonly referred to a drilling mud). The fluid can be captured and conveyed to a separation system at which at least some of the cuttings are removed. The removed cuttings can then be used for sampling. In one arrangement, all of the removed cuttings might be used for sampling; either as a continuous sample for analysis, or by being separated into batches providing individual samples for analysis. In another arrangement, only a portion of the removed cuttings are used for sampling; either as a continuous sample for analysis, or by being separated into batches providing individual samples for analysis.

The drilling fluid may form part of a fluid system, in which the drilling fluid is pumped down the drill string and returns upwardly along an annular space about the drill string, carrying the drilling cuttings. The returning fluid with the entrained drilling cuttings, is referred to herein as the drilling fluid returns.

The drilling fluid returns are captured in any appropriate way; for example, by collection at the upper end of a drill casing which extends into the borehole and along which the drill string passes, with the annular space around the drill string being defined between the drill string and the surrounding portion of the casing.

The fluid system may have a separation system at which at least some of the cuttings are removed from the drilling fluid returns. The separation system may separate the drilling cuttings in any appropriate way. The separation system may, for example, comprise a fluid flow path along which the drilling fluid returns can be conveyed, the fluid flow path incorporating a centrifuge for removal of cutting solids from the drilling fluid. The separation system may comprise part of a solids control system forming part of the fluid system. A solids control system likely to be particularly suitable is of the type disclosed in Australian Patent Applications 2012318265 and 2013204746, the contents of which are incorporated herein by way of reference.

There is need also to relate each sample to the axial location within the borehole at which the particular sample has been collected.

The samples may be taken incrementally by sampling in time intervals which represent specific spatial intervals of the borehole. By way of example, one or more samples may be taken at specific times, each specific time being related generally to the location within the borehole at which the drilling cuttings (providing the sample or samples) have been taken. In this manner, each sample is related to the location within the borehole at which the particular sample has been collected. The incremental samples can in collected and stored individually for subsequent analysis; for example, in sample collection bags.

The drilling cutting removed from the drilling fluid returns are discharged, typically as a continuous feed, although it may be intermittent. The discharging feed needs to be divided into discrete portions, each constituting a discrete sample. The discrete portions are then collected in storage arrangements, such as sample bags, and labelled.

There is a need to manage the discharging feed in a manner which maintains the integrity of the sampling process.

### SUMMARY OF INVENTION

According to a first aspect of the invention there is provided a collection system comprising a conveyor means for receiving a stream of drill cuttings removed from drilling fluid returns and delivering the stream of drill cuttings to a collection zone, and a loading means for sequentially positioning a plurality of sample collection containers at the collection zone to receive discrete quantities of the drilling cuttings, the discrete quantities of the drilling cuttings providing representative samples stored individually in the sample collection containers.

The collected representative samples may be used for analysis. In exploration drilling, the collected representative samples may be correlated to drilling cuttings generated during borehole drilling, relating each sample to the axial location within the borehole at which the particular sample has been collected. The samples may be taken incrementally by sampling in time intervals which represent specific spatial intervals of the borehole. In this manner, each sample is related generally to the location within the borehole at which the particular sample has been collected. The incremental samples can in collected and stored individually in the sample collection containers.

The sample containers may take any appropriate form. In one form, for example, the sample collection containers may comprise sample bags. The sample bags may be presented to the collection zone supported in holders. The holders may comprise pots, and the sample bags may be positioned as liners in the pots. Other arrangements are possible, including for example other types of sample containers receivable in the pots.

The loading means for sequentially positioning a plurality of sample collection containers at the collection zone may comprise a carousel adapted to support the sample collection containers and index them sequentially into position at the collection zone.

The carousel may comprise a stationary portion and a rotary portion mounted on the stationary portion.

The stationary portion may comprise a base portion. The base portion may be selectively adjustable for positional adjustment of the rotary portion. The base portion may, for example, comprise one or more adjustable legs for leveling of the rotary portion.

The rotary portion may comprise a plurality of radial arm structures, each having an inner end section connected to a central hub rotatably supported on the stationary portion and an outer end section adapted to carry a respective one of the sample containers.

The outer end section of each radial arm structure may support a respective holder for one of the sample collection containers.

The radial arm structures may be selectively adjustable in length.

The carousel may have a lock for selectively locking it in each indexed position. The lock may releasably lock the rotary portion against rotation when each one of the sample collection containers is presented at the collection zone to receive the discrete quantity of the drilling cuttings.

The carousel may be rotatable manually or rotatable under the influence of a drive system. In the later case, the drive system may comprise an electromechanical drive.

The conveyor means may comprise an endless conveyor. The endless conveyor may present a load carrying run extending from a loading end at which the stream of drill cuttings removed from drilling fluid returns is received and a discharge end for delivering the stream of drill cuttings to the collection zone.

The load carrying run may be inclined downwardly from the loading end to the discharge end.

The endless conveyor may comprise an endless belt defining the load carrying run and also a return run. In one embodiment, the endless belt comprises a light-weight sheet metal structure.

The endless belt may pass around head and tail drums, at least one of which is driven to effect movement of the endless belt.

The endless conveyor may further comprise a cleaning system for cleaning the endless belt. The cleaning system may comprise scraper system for scraping remnant material from the endless belt.

The cleaning system may function to clean the endless belt after delivery of the respective discrete quantity of the drilling cuttings providing each representative sample. The cleaning of the endless belt assists in avoiding carry-over of remnant drilling cuttings and contamination of the representative samples.

The collection system may further comprise a transfer associated with the collection zone for transferring drilling cuttings discharging from the conveyor means to the particular sample collection container positioned at the collection zone.

More particular, the loading means may include the transfer. The transfer may be mounted on the stationary portion of the carousel.

The transfer may comprise a transfer chute.

The transfer chute may be configured as a hopper having an upper end to receive drilling cuttings discharging from the conveyor means and a lower end to direct the cuttings towards the particular sample collection container positioned at the collection zone.

The hopper may have an entry end section configured as a funnel.

The transfer may define a flow path, at least a portion of which may be defined by a surface conducive to continuous flow of drill cuttings to the sample collection container. For example, at least a portion of the flow path may be defined by a surface having a “non-stick” coating to facilitate continuous flow of drill cuttings to the sample collection container. Where the transfer comprises a hopper having an entry end section configured as a funnel, the entry end section may be defined by a surface conducive to continuous flow of drill cuttings. For example, the entry end section may be provided with the “non-stick” coating.

The collection system may further comprise vibration means for imparting vibration to the transfer to facilitate continuous flow of drill cuttings to the sample collection container.

The vibration means may comprise a vibrator mounted on the transfer. Where the transfer comprises a hopper, the vibrator may be mounted on an external surface of the hopper.

According to a second aspect of the invention there is provided a sample collection system comprising a loading means for sequentially positioning a plurality of sample collection containers at a collection zone, the loading means comprising a carousel adapted to support the sample collection containers and index them sequentially into position at the collection zone.

The loading means and the carousel of the sample collection system according to the second aspect of the invention may have any one or more of the features referred to above in relation to their counterparts in the collection system according to the first aspect of the invention.

According to a third aspect of the invention there is provided a method of collecting samples, the method comprising use of a collection system according to the first or second aspect of the invention.

According to a fourth aspect of the invention there is provided a method of collecting drill cuttings removed from drilling fluid returns to provide representative samples for analysis, the method comprising use of a collection system according to the first or second aspect of the invention.

According to a fifth aspect of the invention there is provided a method of collecting drill cuttings removed from drilling fluid returns to provide representative samples for analysis, the method comprising transporting a stream of the drilling cuttings to a collection zone, and sequentially positioning a plurality of sample collection containers at the collection zone to receive discrete quantities of the drilling cuttings, the discrete quantities of the drilling cuttings providing representative samples stored individually in the sample collection containers.

In one arrangement, the stream may flow continuously during collection of the drilling cuttings, with the continuous stream being periodically intercepted by the sample collection containers as they are sequentially positioned at the collection zone. Each sample collection container receives a quantity of drilling cuttings when it is positioned at the collection station and incepting the stream, with the quantity of drilling cuttings received in the sample collection container at the collection zone constituting the respective discrete quantity.

In another arrangement, the stream may be periodically interrupted; for example, by temporarily terminating the transportation of the drilling cuttings to the collection zone. The stage during which the stream flows between each interruption may correspond to a respective one of the sample collection containers being positioned at the collection zone to receive a quantity of drilling cuttings, with the quantity of drilling cuttings received in the sample collection container at the collection zone constituting the respective discrete quantity.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic perspective view of an embodiment of the collection system operating in conjunction with a separation system in the form of a solids control unit;

FIG. 2 is a schematic perspective view of the embodiment of the collection system;

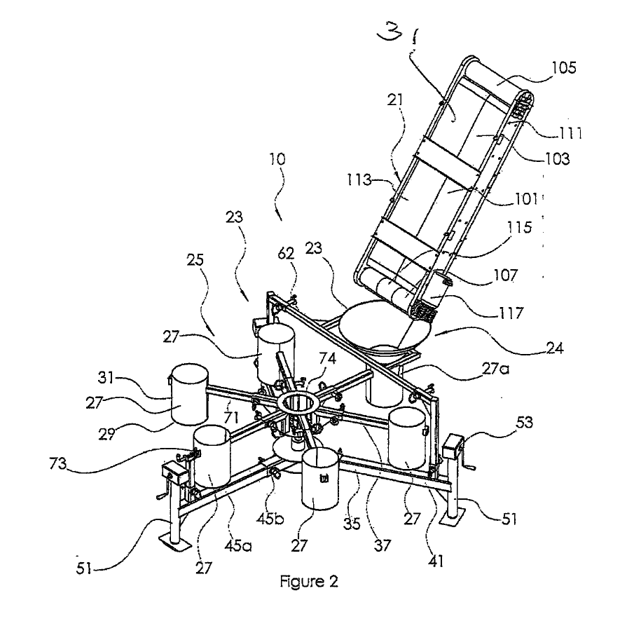

FIG. 3 a schematic perspective view of part of the embodiment, illustrating in particular a carousel and a hopper; and

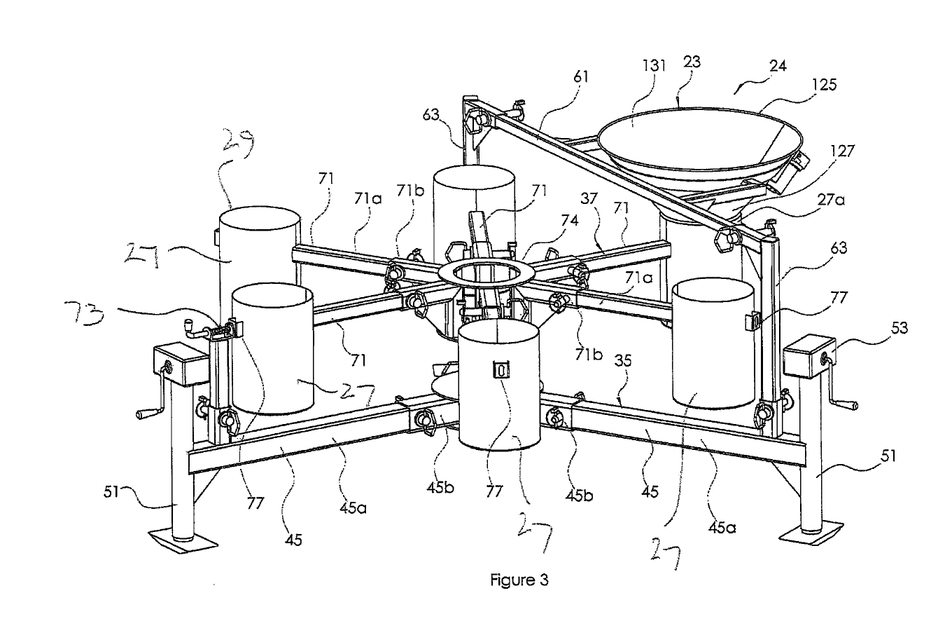

FIG. 4 is a view similar to FIG. 3, but viewed from an opposite side.

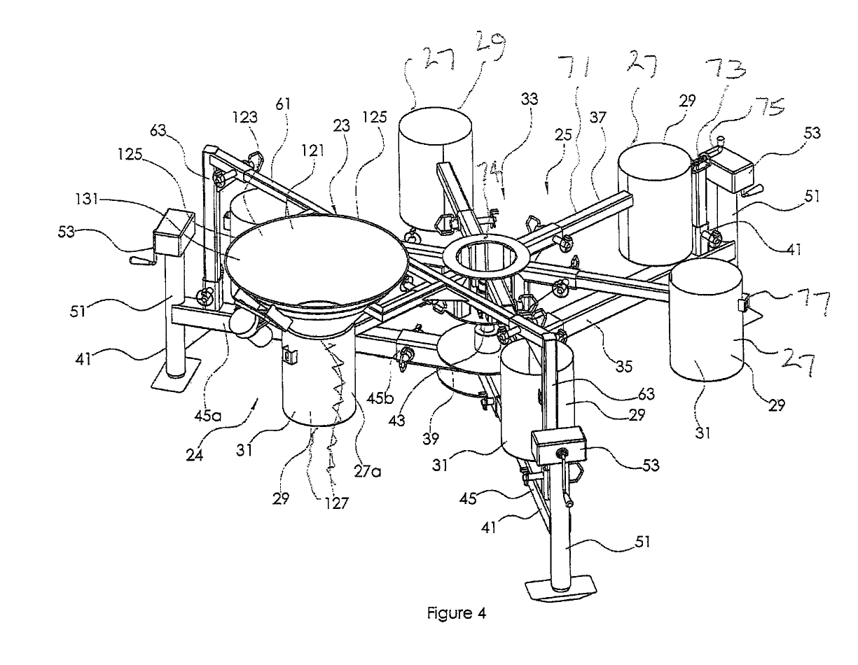

In the drawings like structures are referred to by like numerals throughout the several views. The drawings shown are not necessarily to scale, with emphasis instead generally being placed upon illustrating the principles of the present invention.

The figures which constitute the drawings depict an exemplary embodiment of the invention. The embodiment illustrates certain configurations; however, it is to be appreciated that the invention can take the form of many configurations, as would be obvious to a person skilled in the art, whilst still embodying the present invention. These configurations are to be considered within the scope of this invention.

### DESCRIPTION OF EMBODIMENT

Referring to the drawings, there is shown a collection system 10 for collecting representative samples of drilling cuttings removed from returning drilling fluids which have been cycled through a borehole (not shown) that is being sampled during the drilling process. The drilling process may, for example, comprise exploration drilling, such as mineral exploration drilling by way of diamond drilling.

In a drilling process, the drilling cuttings are conveyed to ground surface in the returning drilling fluid (the drilling fluid returns). The drilling fluid returns are captured and conveyed to a separation system at which at least some of the drilling cuttings (drilling solids) are removed for sampling. In the drawings the separation system is identified by reference numeral 13. The separation system 13 has an outlet (not shown) from which removed drilling cuttings can be discharged as a continuous stream.

The collection system 10 is used to collect the drilling cuttings and package them in discrete quantities as representative samples for subsequent analysis. The collection system 10 can provide consistent, uncontaminated samples of specified or known depth intervals in the borehole being sampled.

The separation system 13 may comprise a solids control system forming part of the drilling fluid system (commonly known as a mud system) used in conjunction with the drilling process. A solids control system likely to be particularly suitable is of the type disclosed in Australian Patent Applications 2012318265 and 2013204746, the contents of which are incorporated herein by way of reference. In a case where the separation system 13 comprises the aforementioned solids control unit, the outlet may be defined by the outlet of a centrifuge.

The drilling cuttings may be collected in batches, with each batch corresponding to the axial location within the borehole at which the particular sample has been collected. The axial location may represent a specified or known depth interval within the borehole. When a representative sample is required corresponding to a specified or known depth interval within the borehole, the drilling fluid returns corresponding to that depth interval are captured and conveyed to the separation system, at which at least some of the drilling cuttings (drilling solids) are removed for sampling. The removed drilling cuttings, which constitute the batch corresponding to the specified or known depth interval, are conveyed to the collection system as a continuous stream of drilling cuttings. The batch of drilling cuttings which is conveyed to the collection system 10 as a continuous stream is then packaged as a discrete quantities as representative samples of the specified or known depth interval within the borehole for subsequent analysis.

With this arrangement, the separation system 13 is operated to yield a batch of drilling cuttings as representative samples for a specified or known depth interval within the borehole.

Typically, the separation system 13 is operated at various stages during a drilling process to yield batches of drilling cuttings when representative samples are required for specified or known depth intervals within the borehole. Each batch of drilling cuttings is conveyed to the collection system 10 as a continuous stream and packaged as discrete quantities, providing representative samples of the specified or known depth interval within the borehole for subsequent analysis.

The collection system 10 comprises a conveyor means 21, a transfer 23, and a loading means 25. In the arrangement shown, the transfer 23 forms part of, and is integrated with, the loading means 25.

The conveyor means 21 comprises a conveyor 31 for receiving a stream of drill cuttings removed from drilling fluid returns by the separation system 13 and delivering the stream of drill cuttings to a collection zone 24 at which the transfer 23 is located. In other words, the conveyor means 21 transports the stream of drill cuttings from the separation system 13 and delivers the stream of drill cuttings to the collection zone 24 via the transfer 23.

The loading means 25 is provided for sequentially positioning a plurality of sample collection containers 27 at the collection zone 24 to receive discrete quantities of the drilling cuttings from the conveyor 31 via the transfer 23, as will be explained in more detail later. The discrete quantities of the drilling cuttings provide representative samples to be stored individually in the sample collection containers 27.

The sample containers 27 may take any appropriate form. In this embodiment, the sample containers 27 comprise sample bags (not shown) presented to the collection zone 24 supported in holders 29. The holders 29 are configured as pots 31 in the arrangement shown, and the sample bags may be positioned as liners in the pots. Typically, one sample bag would be positioned in each pot 31, with the top portion of the bag folded outwardly over the top edge of the pot. In this way, the bag would be supported in an open condition within the pot 29 in readiness to receive sample material. The sample bags may comprise biodegradable plastic bags.

The loading means 25 comprises a carousel 33 adapted to support the sample collection containers 27 and index them sequentially into position at the collection zone 24.

The carousel 33 comprise a base portion 35 and a rotary portion 37 mounted on the base portion for rotation about a vertical axis.

The base portion 35 is selectively adjustable for adjustment of the positioning of the rotary portion 35. The base portion 35 is also selectively collapsible to facilitate transportation and storage.

The base portion 35 comprises a central section 39 mounted on three supports 41. The central section 39 supports an upstanding pivot mounting means 43 upon which the rotary portion 35 is rotatably supported. Each support 41 comprises a boom 45 having an inner end connected to the central section 41 and an outer end supported on a leg 51. Each boom 45 is formed in two sections 45a, 45b which are detachably connected together for assembly and disassembly. The booms 45 can be disassembled to collapse the base portion 35 for transportation and storage. Each leg 51 is selectively adjustable in length, and incorporates an adjustment mechanism 53. The legs 51 are adjustably to set the height of the rotary portion 35 and also for leveling the rotary portion 35.

The base portion 35 also carries the transfer 23. In the arrangement shown, the base portion 35 incorporates a beam 61 supported between two posts 63, with the transfer 23 being mounted on the beam.

The rotary portion 37 comprises a plurality of radial arm structures 71. Each radial arm structure 71 has an inner end section connected to a central hub 74 rotatably supported on the pivot mounting means 43 of the base portion 35. Each radial arm structure 71 also has an outer end section adapted to carry a respective one of the sample collection containers 27. In the arrangement shown, there are six radial arm structure 71 and correspondingly six sample collection containers 27. Other numbers of radial arms structures 71 and sample collection containers 27 are, of course, possible.

Each radial arm structure 71 is selectively adjustable in length. In particular, each radial arm structure 71 is formed in two sections 71a, 71b which are selectively movable one with respect to the other to facilitate adjustment of the length of the radial arm structure. Additionally, the two sections 71a, 71b are detachably connected together for assembly and disassembly. The radial arm structures 71 can be disassembled to collapse the rotary portion 37 for transportation and storage.

The carousel 33 has a lock 73 for selectively locking it in each indexed position. The lock 73 is operable to releasably lock the rotary portion 37 against rotation when each one of the sample collection containers 27 is presented at the collection zone 24 to receive the discrete quantity of the drilling cuttings. In the arrangement shown, the lock 73 comprises a locking bolt 75 mounted on the base portion 35 and a mating cleat 77 mounted on each sample collection container 27. In each indexed position of the carousel, one of the mating cleats 77 is in registration with the locking bolt 75, whereby the locking bolt can be actuated to engage the registering cleat 77 and thereby lock the rotary portion 37 against rotation.

In this embodiment, the carousel 33 is rotatable manually by an operator. In another embodiment, the carousel 33 may be rotatable under the action of a powered drive system such as an electromechanical drive system.

The conveyor means 21 comprise an endless conveyor 101. The endless conveyor 101 presents a load carrying run 103 extending from a loading end 105 at which the stream of drill cuttings removed from drilling fluid returns is received from the outlet of the separation system 13, and a discharge end 107 for delivering the stream of drill cuttings to the transfer 23 at the collection zone 24. The load carrying run 103 is inclined downwardly from the loading end 105 to the discharge end 107.

The endless conveyor 101 comprise an endless belt 111 defining the load carrying run 113 and also a return run (not shown). In this embodiment, the endless belt 111 comprises a light-weight sheet metal structure.

The endless belt 111 passes around a head drum 115 and a tail drum (not shown). The head drum 115 is driven by a drive system 117. The drive system 117 may be of any appropriate form. In this embodiment, the drive system 117 may comprise a worm gear driven by a 12 volt DC motor controlled by a DC speed controller.

The endless conveyor 101 further comprises a cleaning system (not shown) for cleaning the endless belt 111. The cleaning system may comprise a belt scraper (not shown). The cleaning system may function to clean the endless belt 111 during and after delivery of the drilling cuttings providing the representative samples. The cleaning of the endless belt 111 assists in avoiding carry-over of remnant drilling cuttings and contamination of the representative samples.

The transfer 23 is associated with the collection zone 24 for transferring drilling cuttings discharging from the endless conveyor 101 to the particular sample collection container 27a positioned at the collection zone.

The transfer 23 comprises a transfer chute 121. In the arrangement shown, the transfer chute 121 is configured as a hopper 123 having an upper end 125 to receive drilling cuttings discharging from the discharge end 107 of the endless conveyor 101, and a lower end 127 to direct the drilling cuttings towards the particular sample collection container 27a positioned at the collection zone 24. The hopper 123 comprises a conical section 131 which extends downwardly from the upper end 125 and which is configured as a funnel.

The conical section 131 of the hopper 123, which is of inwardly tapered configuration, has an internal surface provided with a “non-stick” coating to facilitate continuous flow of drill cuttings along the hopper to the sample collection container 27a. The “non-stick” coating serves to deter accumulation of particulate material within the drilling cuttings from accumulating on the conical section 131 of the hopper 123.

The transfer 23 may further comprise vibration means (not shown) for imparting vibration to the hopper 123 to facilitate continuous flow of drill cuttings to the sample collection container 27a. The vibration means may comprise a vibrator mounted on an external surface of the hopper 123. The vibrator may be of any appropriate form, as would be understood by a person skilled in the art.

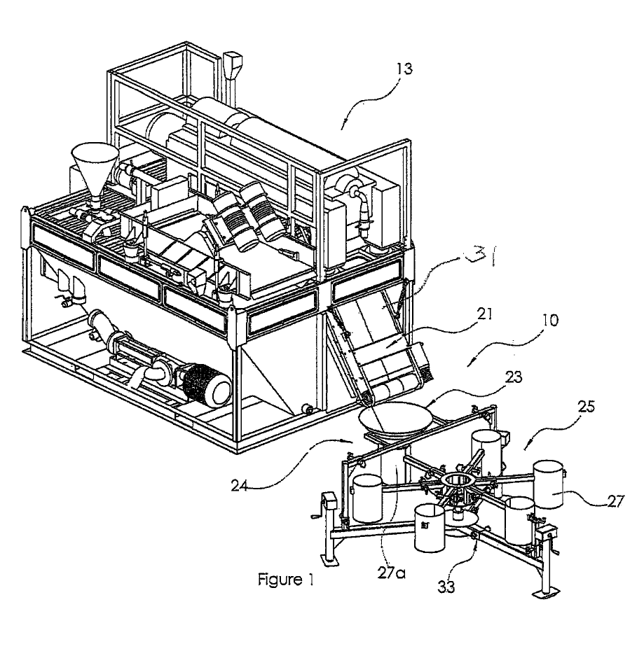

The endless conveyor 101 may be integrated with the separation system 13. This is, in fact, the case in the arrangement shown in FIG. 1, in which the separation system 13 comprises a solids control system of the type disclosed in Australian Patent Applications 2012318265 and 2013204746 and the endless conveyor 101 is an integrated part of the arrangement.

In operation, the collection system 10 is installed adjacent the separation system 13, with the endless conveyor 101 positioned to receive a stream of drilling cuttings removed from drilling fluid returns circulated through the separation system.

When drilling cuttings are required to be collected for a particular stage of the drilling process of an exploration borehole to provide a representative sample for analysis, the drilling cuttings are intercepted and delivered to the collection system 10. The intercepted drilling cuttings provide a representative sample corresponding to a specified or known depth interval within the borehole.

At the collection system 10, the intercepted drilling cuttings are directed to the sample collection container 27a at the collection zone 24, filling the sample collection bag lining the respective holder 29 (pot). Once the sample bag has been filled to the extent required, the carousel 33 is indexed to present the next the sample collection container 27 (pot 31 and associated sample bag) at the collection zone 24 to be filled. The endless conveyor 101 may be operable to deliver the intercepted drilling cuttings continuously to the collection zone during a stage of the drilling process, with the carousel 33 being indexed to sequentially moved the respective sample collection containers 27 into and out of the collection zone 24. With this arrangement, there may be some spillage of drilling cutting at the collection zone in the intervening period as one collection container 27 is moved out of registration with the transfer 23 and the next collection container is moved into registration with the transfer. The extent of loss of drilling cuttings is likely to be considered minimal and not of any consequence. In an alternative arrangement, the conveyor may be intermittently stopped for indexing of the carousel 33.

Once a filled sample collection bag moves away from the collection zone 24 upon indexing of the carousel 33, the filled sample collection bag can be removed from its holder 29 and replaced with an empty bag in readiness to be filled when next at the collection zone 24.

The filled sample bags are closed and marked of identification (such as for example by labelling). The intercepted drilling cuttings packaged in the sample bags provide representative samples (related to the specified or known depth interval within the borehole for the respective drilling stage) for subsequent analysis.

If drilling cutting are required to be collected continuously during the drilling process, or within a specified interval during the drill process, the carousel 33 can be indexed periodically to advance a fresh sample collection bag into position at the collection zone 24 each time the preceding sample collection bag has been filled. By recording the volume of drilling cuttings collected in each sample collection bag, the sample can be related to a depth interval of the borehole.

It should be appreciated that the scope of the invention is not limited to the scope of the embodiment described as an example. For instance, the collection system may be used to collect materials from other fields of endeavour, and also from other drilling technologies, such as reverse circulation (RC) drilling technologies for which there are bagging systems which use a cone slitter or the like to split a sample, a portion of which is collected in a bag.

While the present invention has been described in terms of a preferred embodiment in order to facilitate better understanding of the invention, it should be appreciated that various modifications can be made without departing from the principles of the invention. Therefore, the invention should be understood to include all such modifications within its scope.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment was chosen and described to provide the best illustration of the principle of the described technology and its practical application, and to enable one of ordinary skill in the art to utilise the technology in various embodiments and with various modifications as are suited to the particular use contemplated.

Reference to positional descriptions, such as “upper”, “lower”, “top”, and “bottom”, “front”, “rear” and “side” are to be taken in context of the embodiments depicted in the drawings, and are not to be taken as limiting the invention to the literal interpretation of the term but rather as would be understood by the skilled addressee.

Additionally, where the terms “system”, “device” and “apparatus” are used in the context of the invention, they are to be understood as including reference to any group of functionally related or interacting, interrelated, interdependent or associated components or elements that may be located in proximity to, separate from, integrated with, or discrete from, each other.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A collection system comprising a conveyor means for receiving a stream of drill cuttings removed from drilling fluid returns and delivering the stream of drill cuttings to a collection zone, and a loading means for sequentially positioning a plurality of sample collection containers at the collection zone to receive discrete quantities of the drilling cuttings, the discrete quantities of the drilling cuttings providing representative samples stored individually in the sample collection containers.

2. The collection system according to claim 1 wherein the sample collection containers comprise bags, and wherein the collection system further comprises holders for the bags.

3. The collection system according to claim 1 wherein the loading means comprises a carousel adapted to support the sample collection containers and index them sequentially into position at the collection zone.

4. The collection system according to claim 3 wherein the carousel comprises a stationary portion and a rotary portion mounted on the stationary portion.

5. The collection system according to claim 4 wherein the stationary portion comprises a base portion selectively adjustable for adjustment of the positioning of the rotary portion.

6. The collection system according to claim 4 wherein the rotary portion comprises a plurality of radial arm structures, each having an inner end section connected to a central hub rotatably supported on the stationary portion and an outer end section adapted to carry a respective one of the sample containers, the radial arm structures being selectively adjustable in length.

7. The collection system according to claim 3 wherein the carousel comprises a lock for selectively locking it in each indexed position.

8. The collection system according to claim 1 wherein the conveyor means comprises an endless conveyor.

9. The collection system according to claim 8 wherein the endless conveyor further comprise a cleaning system for cleaning the endless belt.

10. The collection system according to claim 1 further comprising a transfer associated with the collection zone for transferring drilling cuttings discharging from the conveyor means to the particular sample collection container positioned at the collection zone.

11. The collection system according to claim 10 wherein the transfer is mounted on the stationary portion of the carousel.

12. The collection system according to claim 10 wherein the loading means includes the transfer.

13. The collection system according to claim 10 further comprising further comprise vibration means for imparting vibration to the transfer.

14. A sample collection system comprising a loading means for sequentially positioning a plurality of sample collection containers at a collection zone, the loading means comprising a carousel adapted to support the sample collection containers and index them sequentially into position at the collection zone.

15. The collection system according to claim 14 further comprising a transfer for transferring drilling cuttings to the particular sample collection container positioned at the collection zone, the transfer being mounted on the carousel.

16. A method of collecting samples, the method comprising use of a collection system according to claim 1.

17. A method of collecting drill cuttings removed from drilling fluid returns to provide representative samples for analysis, the method comprising use of a collection system according to claim 1.

18. A method of collecting drill cuttings removed from drilling fluid returns to provide representative samples for analysis, the method comprising transporting a stream of the drilling cuttings to a collection zone, and sequentially positioning a plurality of sample collection containers at the collection zone to receive discrete quantities of the drilling cuttings, the discrete quantities of the drilling cuttings providing representative samples stored individually in the sample collection containers.

19. The method according to claim 18 wherein the stream flows continuously during collection of the drilling cuttings and wherein the continuous stream is intercepted by the sample collection containers when sequentially positioned at the collection zone.

20. The method according to claim 18 wherein the stream is periodically interrupted and wherein a respective one of the sample collection containers is positioned at the collection zone to receive a quantity of drilling cuttings at each stage during which the stream flows between the interruptions.
